(19) United States
(12) Patent Application Publication
(10) Pub. No.: US 2007/0168190 A1
(43) Pub. Date: Jul. 19, 2007

(54) Information processing apparatus with speech recognition capability, and speech command executing program and method executed in information processing apparatus

(75) Inventor: Kazuhiro Itagaki, Toyonaka-shi (JP)

Correspondence Address: BUCHANAN, INGERSOLL & ROONEY PC, POST OFFICE BOX 1404, ALEXANDRIA, VA, 22313-1404, US

(73) Assignee: KONICA MINOLTA BUSINESS TECHNOLOGIES, INC., Tokyo (JP)

(21) Appl. No.: 11/589,256

(22) Filed: Oct. 30, 2006

(30) Foreign Application Priority Data
Jan. 16, 2006 (JP) 2006-007730

(51) Int. Cl. G10L 17/00

(52) U.S. Cl. 704/246

(57) ABSTRACT

To facilitate entry of instructions and ensure security, an MFP includes a HDD which previously stores voiceprint data to authorize a user with voiceprint, a communication control element which receives speech, a voiceprint verifying element which verifies the voiceprint of the received speech with the voiceprint data, a speech recognizing element which recognizes the received speech and outputs text data when the voiceprint verification succeeds in the voiceprint verifying element, and an operation processing element which executes operations in accordance with the text data.

This application is based on Japanese Patent Application No. 2006-007730 filed with Japan Patent Office on Jan. 16, 2006, the entire content of which is hereby incorporated by reference.

### BACKGROUND OF THE INVENTION

1. Field of the Invention

The present invention relates to an information processing apparatus with a speech recognition capability, and a program and a method for executing speech commands. More particularly, the present invention relates to an information processing apparatus with speech recognition capability, and a speech command executing program and a method executed in the information processing apparatus.

2. Description of the Related Art

Recently, printers for printing data in compliance with user authentication have been proposed to ensure security of data printed by such printers. For example, the Japanese Patent Laid-Open Publication No. 2002-351627 discloses an information output system wherein a print order to print retrieved data and user identification (ID) information are previously sent to a printer, and when a user subsequently enters his/her user ID information and the entered user ID information is judged to match the previously sent user ID information, the printer is enabled to print retrieved data. A problem of this system, however, is the need for entry of two types of information including the print order and the user ID information for user authentication.

In the meantime, in accordance with the development of a speech recognition technique, image forming apparatus capable of receiving speech commands to execute operations have been proposed. For example, the Japanese Patent Laid-Open Publication No. 2002-287796 discloses an image forming apparatus wherein a speech recognition element recognizes an instruction included in speech received via a microphone and a control signal generating element generates a control signal corresponding to the instruction. The generated control signal controls the operation of the function executing element of the image forming apparatus. However, as in the information output system described in the above publication No. 2002-351627, the apparatus also requires the entry of authentication information to authenticate users in addition to the entry of speech instructions, if it is desired to authenticate users to ensure security.

### SUMMARY OF THE INVENTION

The present invention has been made to solve the problem set forth above, and one object of the present invention is to provide an information processing apparatus which facilitates entry of commands while ensuring security of the apparatus.

Another object of the present invention is to provide a speech command executing program and a method for executing the program, which facilitate entry of commands to the information processing apparatus while ensuring security of the apparatus.

To achieve the above objects, according to one aspect of the present invention, an information processing apparatus includes a voiceprint data storage element which previously stores voiceprint data including voiceprint for authenticating users with the voiceprint, a speech receiving element which receives speech, a voiceprint verifying element which verifies the received speech with the voiceprint data, a speech recognizing element which recognizes the received speech and outputs data corresponding to the received speech, when the voiceprint verification succeeds in the voiceprint verifying element, and an operation processing element which executes operations in accordance with the data corresponding to the received speech.

Preferably, the information processing apparatus further includes a data storage element which stores data. The operation processing element includes an extracting element which extracts data identification information for identifying data to be processed and destination designation information for designating a destination of the data from the data corresponding to the received speech. The operation processing element also includes a data output element which reads the data identified by the data identification information and outputs the data in accordance with the destination designation information, when the data identification information and the destination designation information are extracted in the extracting element.

Preferably, the information processing apparatus further includes a data acquiring element which acquires data and a data storage element which stores data. The operation processing element includes an extracting element which extracts the data identification information from the data corresponding to the received speech, and a writing element which adds the extracted data identification information to the output data from the data acquiring element and writes the data and the data identification information into the data storage element, when the data identification information is extracted by the extracting element.

According to another aspect of the present invention, a speech command executing program is executed in an information processing apparatus having a voiceprint data storage element which previously stores voiceprint data including voiceprint for authenticating users with the voiceprint. The program causes the information processing apparatus to execute the steps of receiving speech, verifying the received speech with the voiceprint data, recognizing the received speech and outputting data corresponding to the received speech when the voiceprint verification succeeds in the voiceprint verifying step, and executing operations in accordance with the data corresponding to the received speech.

According to a further aspect of the present invention, a speech command executing method is executed in an information processing apparatus having a voiceprint data storage element which previously stores voiceprint data including voiceprint for authenticating users with the voiceprint. The method includes the steps of receiving speech, verifying the received speech with the voiceprint data, recognizing the received speech and outputting data corresponding to the received speech when the voiceprint verification succeeds in the voiceprint verifying step, and executing operations in accordance with the data corresponding to the received speech.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is an overall schematic diagram illustrating an information processing system according to an embodiment of the present invention;

FIG. 2 is a perspective view of an appearance of a MFP;

FIG. 3 is a block diagram illustrating an example of a hardware structure of the MFP;

FIG. 4 is a functional block diagram illustrating an overall function of the CPU in the MFP and a list of information stored in the HDD;

FIG. 5 is an example of destination data;

FIG. 6 is a flow chart illustrating an example of a data registration procedure executed in the CPU of the MFP; and

FIG. 7 is a flow chart illustrating an example of a data output procedure executed in the CPU of the MFP.

### DESCRIPTION OF THE PREFERRED EMBODIMENTS

The present invention will be described below with reference to the accompanying drawings. In the drawings, like numerals indicate similar elements which are designated the same way and perform the same function, and the detailed description thereof will not be repeated.

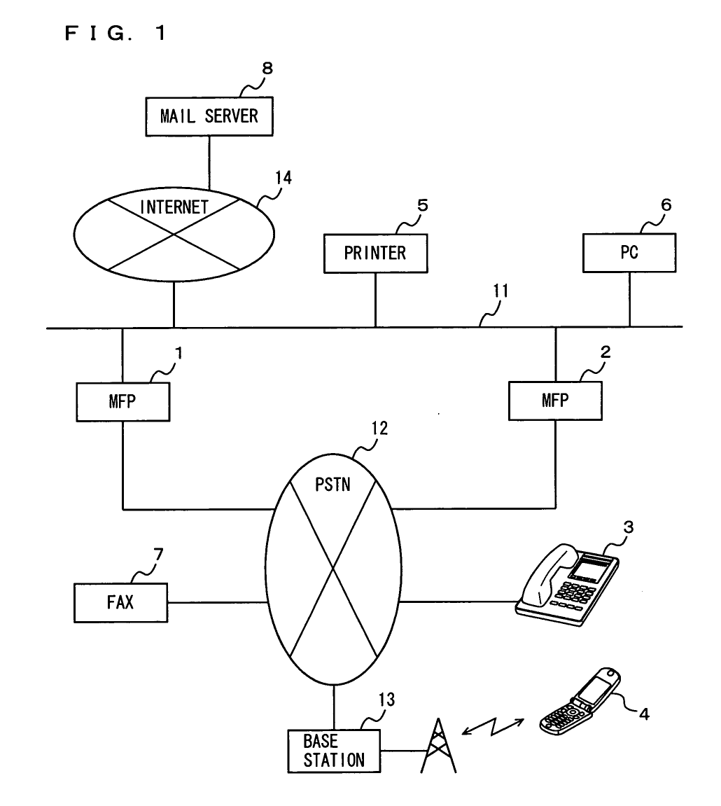

Referring to FIG. 1, there is shown an overall schematic diagram of an information processing system according to an embodiment of the present invention. As show in FIG. 1, the information processing system includes two MFPs 1 and 2, a printer 5 and a personal computer (hereinafter referred to as “PC”) 6, and these components are connected one another via a local area network (LAN) 11 which further connects to the Internet 14. The MFPs 1 and 2 perform various functions including copying, scanning, facsimile transmission/receiving, and printing. The LAN 11 may be implemented in a wired or wireless configuration. The printer 5 and the PC 6 have well known hardware structures and functions and the detailed description thereof will not be provided. The MFP 1 and 2 are capable of sending/receiving data to and from the printer 5 and the PC6 via the LAN 11. The MFP 1 and 2 are also capable of sending electronic mails (e-mails) to a mail server 8 via the LAN 11 and the Internet 14. It is noted that although two MFPs 1 and 2 are connected to the LAN 11 in the illustrated figure, any number of MFPs may be connected thereto.

The MFPs 1 and 2 are also connected to a pubic switched telephone network (PSTN) 12, so that the MFPs 1 and 2 can send/receive facsimile data to and from a facsimile (FAX) machine 7 connected to the PSTN 12. In addition, the MFPs 1 and 2 can establish a telephone call between the MFP and an ordinary subscriber telephone 3 connected to the PSTN 12 to send/receive speech data. Further, the MFPs 1 and 2 can establish a telephone call between the MFP and a cellular phone 4 connected to the PSTN 12 via a base station 13 to send/receive speech data. It is noted that although the MFPs 1 and 2 are connected to the PSTN 12 in the illustrated figure, other networks including digital communication networks such as an integrated services digital network (ISDN) capable of communicating speech may be used or, alternatively, an Internet protocol (IP) telephone utilizing the Internet 14 may be used.

In the present embodiment, the MFPs 1 and 2 establish a call with the telephone 3 or the cellular phone 4 and, when an order in speech format (hereinafter referred to as “speech command”) is received from either the telephone 3 or the cellular phone 4, outputs data which is previously stored in the MFPs 1 and 2 to the printer 5, the PC 6, the FAX 7, or the mail server 8. As the MFPs 1 and 2 are identical in both structure and functions, only the MFP 1 will be described as an illustrative example in the description below.

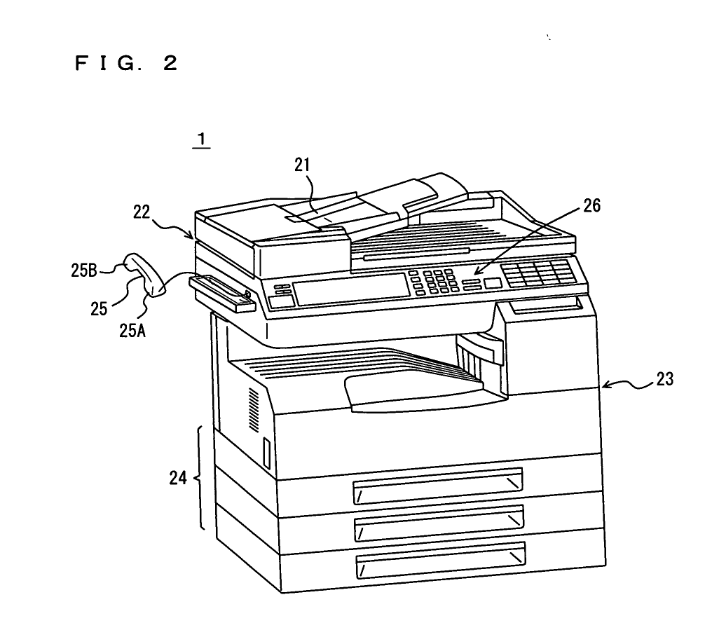

Referring to FIG. 2, there is shown a perspective view of an appearance of the MFP. As shown in FIG. 2, the MFP 1 includes an automatic document feeder (ADF) 21, an image reader element 22, an image forming element 23, a paper feeder element 24 and a handset 25. The ADF 21 handles multiple sheets of documents mounted on a document platform to feed the documents one sheet after another to the image reader element 22. The image reader element 22 optically reads image information such as pictures, letters and drawings from the documents to acquire image data. When the image data is supplied, the image forming element 23 prints an image on a recording medium, e.g., a sheet of paper, in accordance with the received image data. The paper feeder element 24 stores recording sheets and supplies the sheets one by one to the image forming element 23. The handset 25 includes a microphone 25A and a speaker 25B and is operable by a user when he/she uses the MFP 1 as a telephone or enters his/her speech thereto. The MFP 1 also includes a control panel 26 on the top surface thereof.

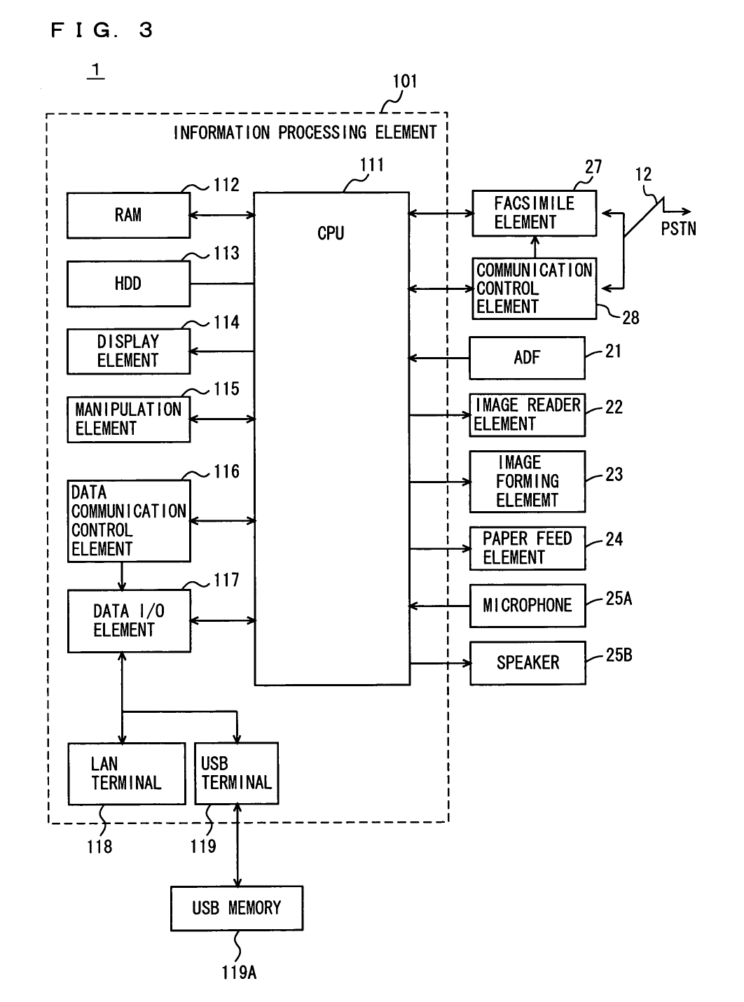

FIG. 3 is a block diagram of an exemplary hardware structure of the MFP. As shown in FIG. 3, the MFP 1 includes an information processing element 101, a facsimile element 27, a communication control element 28, the ADF 21, the image reader element 22, the image forming element 23, and the paper feeder element 24, the microphone 25A and the speaker 25B. The information processing element 101 includes a central processing unit (CPU) 111, a random access memory (RAM) 112 which is used as a working area of the CPU 111, a hard disc drive (HDD) 113 which stores data in a nonvolatile manner, a display element 114, a manipulation element 115, a data communication control element 116, and a data input/output (I/O) element 117. The CPU 111 is connected to the data I/O element 117, the data communication control element 116, the manipulation element 115 and the display element 114, in order to control the entire information processing element 101. The CPU 111 is also connected to the facsimile element 27, the communication control element 28, the ADF 21, the image reader element 22, the image forming element 23, and the paper feeder element 24, the microphone 25A and the speaker 25B in order to control the entire MFP 1.

The display element 114 is implemented by a display device such as a liquid crystal display (LCD) and an organic electroluminescence display (EL), and displays a menu of instructions or the information of acquired image data toward users. The manipulation element 115 includes a plurality of keys for entering data including various instructions, letters and numerals by manipulating individual keys by the user. The manipulation element 115 also includes a touch panel provided on the display element 114. The display element 114 and the manipulation element 115 form the control panel 26.

The data communication control element 116 is connected to the data I/O element 117. The data communication control element 116 controls the data I/O element 117 in response to an instruction from the CPU 11, and transmits/receives data to and from external devices connected to the data I/O element 117. The data I/O element 117 includes a LAN terminal 118 which is used to provide communication in accordance with a communication protocol such as a transmission control protocol (TCP) or a file transfer protocol (FTP) and a universal serial bus (USB) terminal 119.

When a LAN cable is connected to the LAN terminal in order to connect to the LAN 11, the data communication control element 116 controls the data I/O element 117 to communicate with the MFP 2, the PC 6 and the printer 5 connected to the LAN 11 via the LAN terminal 118, and to further communicate with the mail server 8 connected to the LAN via the Internet 14. When a certain device is connected to the USB terminal 119, the data communication control element 116 controls the data I/O element 117 to communicate with the connected device to input/output data. A USB memory 119A including a built-in flash memory can be connected to the USB terminal 119. The USB memory 119A previously stores a speech command executing program which will be described later. The CPU 111 controls the data communication control element 116 to read the speech command executing program from the USB memory 119A, stores it in the RAM 112 and executes it.

The USB memory 119A is one type of recording medium storing the speech command executing program, and other medium capable of bearing the program in a fixed manner, such as a flexible disc, cassette tape, an optical disc, compact disc-read only memory (CD-ROM), magnetic optical disc (MO), mini disc (MD), digital versatile disc (DVD), an IC card (including memory card), an optical card, and a semiconductor memory such as mask ROM, erasable programmable ROM (EPROM), and electronically erasable programmable ROM (EEPROM) may be used. Alternatively, the CPU 111 may download the speech command executing program from a computer connected to the Internet 14 and stores it in the HDD 113, or the computer connected to the Internet 14 may write the speech command executing program in the HDD 113. The speech command executing program stored in the HDD 113 is then loaded to the RAM 112 and executed by the CPU 111. In the present embodiment, the term “program” includes not only a program executable directly by the CPU 111, but also other programs such as source-type programs, compressed programs and encrypted programs.

The facsimile element 27 is connected to the PSTN 12 and transmits and/or receives facsimile data to and from the PSTN 12. The facsimile element 27 provides the received data to the image forming element 23 after converting it into print data which is printable in the image forming element 23. In response, the image forming element 23 prints the facsimile data received from the facsimile element 27 on a sheet of recording medium. The facsimile element 27 also converts the data stored in the HDD 113 into facsimile data and transmits it to the FAX 7 or the MFP 2 connected to the PSTN 12, to thereby output the data stored in the HDD 113 at the FAX 7 or the MFP 2.

The communication control element 28 is implemented by a modem which enables the CPU 111 to connect to the PSTN 12. The communication control element 28 allows the telephone 3 connected to the PSTN 12, or the cellular phone 4 connected to a base station 13 by wireless, to establish a call to provide speech communication. The MFP 1 has a telephone number which is previously assigned to the MFP1 in the PSTN 12. When the telephone 3 or the cellular phone 4 originates a call to the telephone number assigned to the MFP 1, the communication control element 28 detects the incoming call and establishes the call. If the communication control element 28 detects the calling and establishes the call originated by the FAX 7 or the MFP 2, the facsimile element 27 is designated to provide communication. In the meantime, if the call came from the telephone 3 or the cellular phone 4, the communication control element 28 establishes the call with the telephone 3 or the cellular phone 4 to provide speech communication. When the call is established with the telephone 3 or the cellular phone 4, the communication control element 28 outputs speech data sent from the telephone 3 or the cellular phone 4 to the CPU 111 and vice versa.

The microphone 25A collects the spoken voice of users and outputs analog speech data to the CPU 111. Namely, the microphone 25A functions as an input device for entering speech to the MFP 1, while the CPU 111 obtains the speech data provided from the microphone 25A. The speaker 25B generates sound in accordance with the analog speech data supplied from the CPU 111.

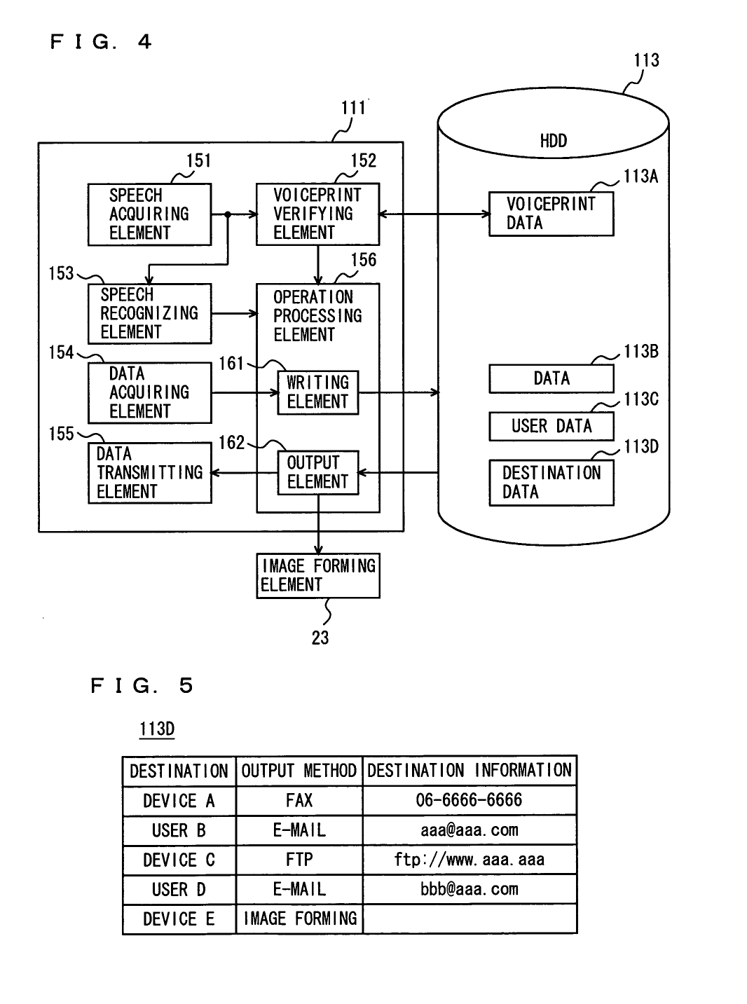

FIG. 4 is a functional block diagram illustrating an overall function of the CPU in the MFP and a list of information stored in the HDD. As shown in FIG. 4, the HDD 113 stores voiceprint data 113A, data 113B, user data 113C and destination data 113D. The voiceprint data 113A is the data that associates the voiceprint of users with user identification information for identifying the user. For example, the voiceprint data 113A is generated based on the speech data supplied from the user by vocalizing predetermined letters through the microphone 25A. The generated data is then associated with the user identification information for identifying the user and is previously stored in the HDD 113. Preferably, the predetermined letters include, for example, alphanumeric letters such as “.”, “@”, “-”, “_”, etc. that are used for describing the name of files and devices. Instead of entering the speech through the microphone 25A, the voiceprint data may be generated through other devices and stored in the USB memory 119A, and the voiceprint data is read from the USB memory 119A and stored in the HDD 113. The data 113B is subject to the output process, which will be described later, and is stored in the HDD 113 with the data identification information such as file names for identifying data attached thereto. The user data 113C includes the user identification information for identifying the user associated with the data identification information (file name). Using the user data 113C, the data 113B can be classified by users.

The destination data 113D defines destinations of data and is previously stored in the HDD 113. FIG. 5 is an example of destination data. As shown in FIG. 5, the destination data 113D associates the name of the destination, the output method, and the destination information with one another. The name of the destination is the information for identifying the destination, such as a device name which is the device identification information for identifying the destined device, a user name for identifying the user at the destination, and so on. The output method designates any method selected from facsimile transmission, e-mail transmission, file transfer (FTP) and image processing. The destination information identifies the destination of the data output via the selected output method, wherein a facsimile number is designated for facsimile transmission, an e-mail address is designated for e-mail transmission, and a Uniform Resource Locator (URL) is designated for file transfer (FTP). As an example, the destination name “device A” is associated with the output method of “FAX” and the destination information of a facsimile number “06-6666-6666”. It is noted that the MFP 1 itself may be designated as the destination of data and the device identification information of the MFP 1 is indicated by “device E” in FIG. 5. The “device E” is associated with the output method of image forming process by the image forming element 23, and no destination is specified because it is unnecessary for the device E.

Referring back to FIG. 4, the CPU 111 includes a speech acquiring element 151 for acquiring input speech, a voiceprint verifying element 152 for verifying the received speech, a speech recognizing element 153 for recognizing the received speech to output text data, a data acquiring element 154 for acquiring data to be sent, an operation processing element 156 for executing an operation in response to a received control command, and a data transmitting element 155 for sending the data to a designated destination.

The speech acquiring element 151 acquires speech data output from the microphone 25A. When the user puts the handset 25 off the hook and uses the microphone 25A to enter his/her speech, the microphone 25A converts the input speech into speech data of electric signals and outputs the speech data to the CPU 111. The speech acquiring element 151 also acquires the speech data from the communication control element 28. When the calling from the telephone 3 or the cellular phone 4 is detected and the call is established, the communication control element 28 receives the speech data sent from the telephone 3 or the cellular phone 4, and outputs the speech data to the CPU 111. The speech acquiring element 151 acquires the speech data from either the microphone 25A or the communication control element 28, and outputs the speech data to the voiceprint verifying element 152 and the speech recognizing element 153.

The voiceprint verifying element 152 verifies the voiceprint of the speech data using the voiceprint data 113A stored in the HDD 113, and outputs a verification result to the operation processing element 156. When the verification succeeds, the voiceprint verifying element 152 outputs the user identification information of the authenticated user to the operation processing element 156. If the HDD 113 stores multiple pieces of voiceprint data 113A, the voiceprint verifying element 152 verifies the speech data from the speech acquiring element 151 using every piece of the multiple pieces of voiceprint data 113A stored in the HDD 113. Subsequently, the voiceprint verifying element 152 outputs the verified voiceprint and the user identification information associated with the verified voiceprint by the voiceprint data 113A to the operation processing element 156.

The speech recognizing element 153 recognizes the speech data to generate text data, and outputs the generated text data to the operation processing element 156. In the present embodiment, it is assumed that the user enters his/her voice into the microphone 25A by reading out a file name. Therefore, when the speech data is entered to the speech acquiring element 151 via the microphone 25A, the text data output from the speech recognizing element 153 includes the file name. It is also assumed in the present embodiment that the user enters his/her voice from the telephone 3 by reading out the name of the destination to designate the destination of data and the name of the file to identify the data to be output. Therefore, when the speech data is entered to the speech acquiring element 151 from the communication control element 28, the text data output from the speech recognizing element 153 includes both the name of the destination and the name of the file. The name of the destination is the destination identification information for designating the destination.

The data acquiring element 154 receives image data from the image reader element 22 and provides the image data to the operation processing element 156.

When a control command is received, the operation processing element 156 executes an operation in response to the control command. The operation processing element 156 includes a writing element 161 and an output element 162. When the speech data is input to the speech acquiring element 151 via the microphone 25A, such as when the off-the-hook state of the handset 25 is detected, the operation processing element 156 receives the control command to execute the data writing process and enables the writing element 161. The writing element 161 receives the text data including the file name from the speech recognizing element 153, the image data from the data acquiring element 154, and the user identification information from the voiceprint verifying element 152. In response to the control command, the writing element 161 adds the file name to the image data and stores it in the HDD 113, and generates the user data that associates the file name with the user identification information and stores the user data in the HDD 113. As a result, the data 113 B that is the image data labeled with the file name, and the user data 113C are stored in the HDD 113.

In the meantime, when the speech data is entered to the speech acquiring element 151 from the communication control element 28, the operation processing element 156 receives the control command to execute the data output process and enables the output element 162. The output element 162 receives the text data including the file name and the destination name from the speech recognizing element 153, and the user identification information from the voiceprint verifying element 152. The output element 162 reads the data 113B including the file name from the HDD 113, and also reads the destination data 113D including the destination name from the HDD 113. Subsequently, the output element 162 outputs the data 113B including the file name, to the destination designated in the destination information, by the output method associated with the destination name in the destination data 113D. In addition to the image data written in the HDD 113 by the writing element 161, the data 113B may include other data stored in the HDD 113, such as data received from the PC 6, the mail server 8 and the FAX 7 via facsimile transmission.

The output element 162 outputs the data 113B, provided that the HDD 113 stores the user data 113C including the user identification information and the file name. By allowing the output of the data 113B only if it is associated with the user identification information of the user who is authenticated by the voiceprint verification, it is possible to ensure security of the data 113B. If the output method of FAX, e-mails, or FTP is chosen, the output element 162 outputs the retrieved data 113B together with the destination information to the data transmitting element 155, while providing the data read from the HDD 113 to the image forming element 23 if the output method of image forming is chosen.

Instead of the destination name, if the e-mail address, the facsimile number, the URL required for file transfer, or the like is entered as the destination identification information, the output element 162 outputs the data 113B including the file name in accordance with the received destination identification information without reading the destination data 113D. In this case, it is not necessary to store the destination data 113D in the HDD 113.

When the output method of “FAX” is entered, the data transmitting element 155 provides the destination information and the data 113B to the facsimile element 27 to cause it to originate a call to the facsimile number designated by the destination information, so as to fax the data 113B. If the output method of “e-mail” is entered, the data transmitting element 155 generates an e-mail, which includes the data 113B in the body of the mail or as an attached file and is destined for the e-mail address designated by the destination information, and sends the generated e-mail to the mail server 8. In addition, if the output method of “FTP” is entered, the data transmitting element 155 causes the data communication control element 116 to send the data 113B to the URL identified by the destination information according to the FTP.

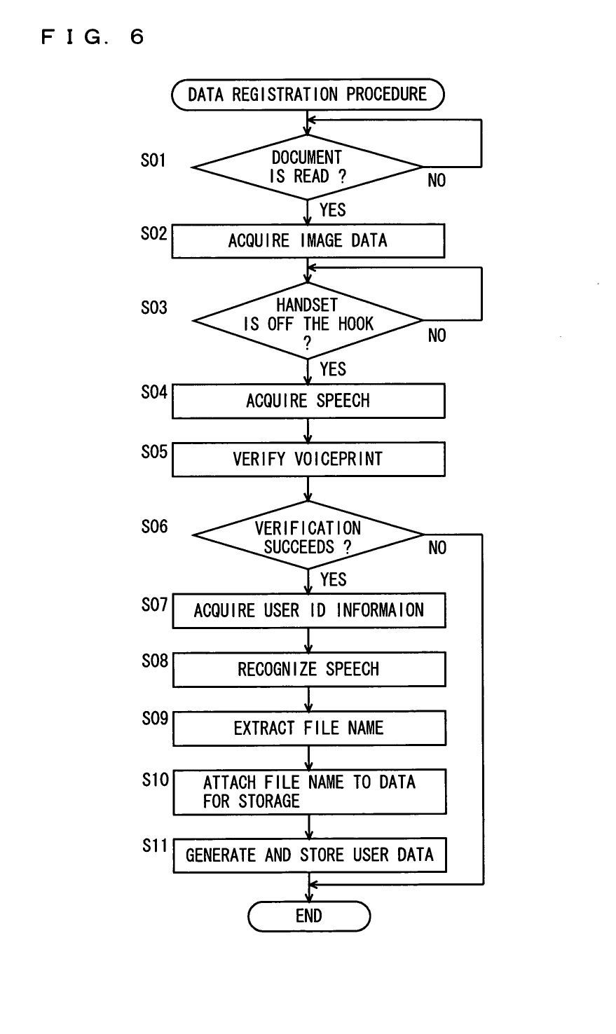

Referring FIG. 6, there is shown a flow chart illustrating an exemplary data registration procedure executed in the CPU of the MFP. As shown in FIG. 6, the CPU 111 firstly determines whether or not a document is read in a scanner mode at the image reader element 22 (step S01). If the document reading is done, the process proceeds to step S02, otherwise the process enters the waiting mode until the document is read. In step S02, the image data output from the image reader element 22 as a result of reading the document is acquired and temporarily stored in the RAM 112.

Then, it is determined whether or not the handset 25 is off the hook (step S03) and, if the off-the-hook state is detected, the process proceeds to step S04, otherwise the process enters the waiting mode. In step S04, speech data output via the microphone 25A is acquired. It is noted that the order of executing the steps S01 and S02 and the steps S03 and S04 may be switched so that the image data may be acquired after receiving the speech data.

In step S05, the speech data acquired in step S04 is verified using the voiceprint data 113A stored in the HDD 113. The CPU 111 extracts from the HDD 113 the voiceprint data 113A including the voiceprint that matches the voiceprint of the speech data acquired in step S04. Then, it is determined whether or not the voiceprint verification succeeds (step S06) and, if the verification was successful, the process proceeds to step S07. If the verification failed, the process ends. When the voiceprint data 113A including the voiceprint that matches the speech data acquired in step S04 is extracted from the HDD 113, the CPU 111 determines the success of verification, otherwise it determines the failure of verification. When the verification fails, the data is not stored in the HDD 113 in order to ensure security of the data 113B stored in the HDD 113.

In step S07, the user identification information of the user who originated the speech of the speech data acquired in step S04 is acquired. The CPU 111 acquires the user identification information included in the voiceprint data 113A extracted from the HDD 113 in step S05. Then, the speech recognition of the speech data acquired in step S04 is carried out to provide text data (step S08). The file name is extracted from the text data (step S09), and the file name extracted in step S09 is added to the image data acquired in step S02 and stored in the HDD 113 (step S10). As a result, the data 113B is stored in the HDD 113. In addition, the CPU 11 associates the user identification information acquired in step S07 with the file name extracted in step S09 to generate the user data 113C and stores it in the HDD 113 (step S11).

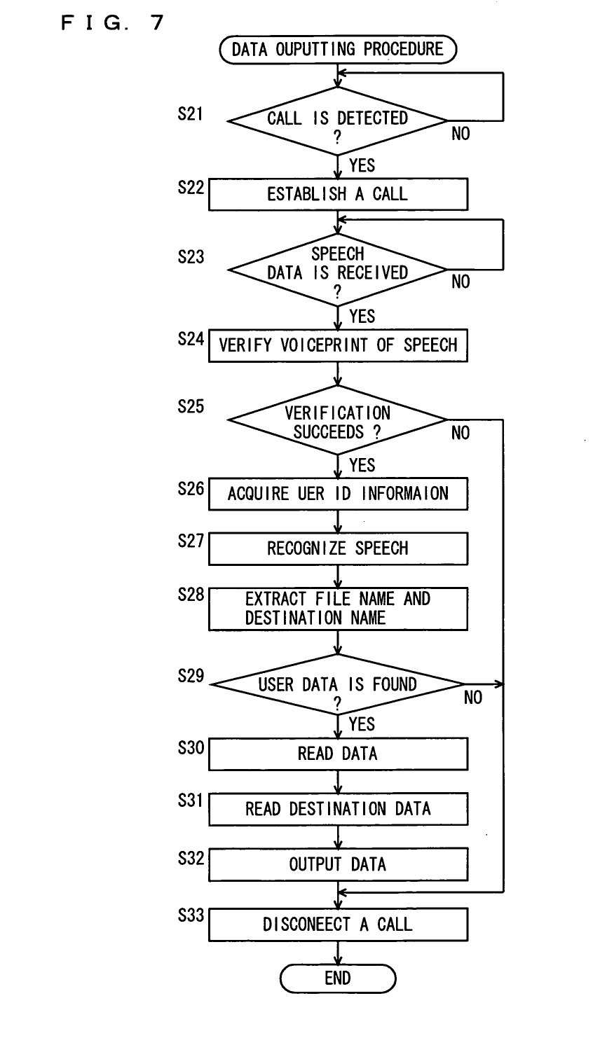

Referring to FIG. 7, there is shown a flow chart illustrating an exemplary data output procedure executed in the CPU of the MFP. As shown in FIG. 7, the CPU 111 determines whether or not an incoming call is detected by the communication control element 28 (step S21) and, if the incoming call is detected, establishes the call (step S22), otherwise the CPU 111 enters the waiting mode until the incoming call is detected. In short, the data output procedure is initiated provided that the communication control element 28 detects the incoming call. The CPU 111 is in the waiting mode until the speech data is entered (NO at step S23) and when the speech data is received (YES at step S23), the CPU 111 verifies the voiceprint of the speech data using the voiceprint data 113A (step S24). It is then determined whether or not the voiceprint verification succeeds (step S25) and, if the voiceprint verification was successful, the process proceeds to step S26, otherwise the process goes to step S33 where the call, that was established in step S22, is disconnected. This is to ensure security of the data 113B stored in the HDD 113 by prohibiting the output of the data to the HDD 113 when the voiceprint verification fails.

In step S26, the user identification information of the user who originated the speech of the speech data received in step S23 is acquired. The CPU 111 acquires the user identification information included in the voiceprint data 113A extracted from the HDD 113 in step S25. Then, the speech recognition of the speech data acquired in step S23 is carried out to generate text data (step S27), and the file name and the destination name are extracted from the text data (step S28).

The CPU 111 determines whether or not the user data 113C that includes the user identification information acquired in step S26 and the file name extracted in step S28 is stored in the HDD 113 (step S29). If such user data 113C is stored in the HDD 113, the process proceeds to step S30. Otherwise, the process goes to step S33 to prohibit the output of the data that is not associated with the user identification information of the user whose voiceprint was verified, to thereby ensure security of the data 113B stored in the HDD 113.

The data 113B labeled with the file name that is extracted in step S28 is read from the HDD 113 (step S30), while the destination data 113D including the destination name extracted in step S28 is also read from the HDD 113 (step S31). Then, the data 113B acquired in step S30 is output by the designated output method to the designated destination of the destination information in accordance with the data 113D acquired in step 31 (step S32). Specifically, if the output method of FAX is chosen in the destination data 113D, the data 113B is provided together with the destination information to the facsimile element 27 which, in turn, originates a call to the facsimile number specified in the destination information to fax the data 113B. If the output method of e-mail is chosen in the destination information, an e-mail which includes the data 113B in the body of the mail or as an attached file and is destined for the e-mail address specified in the destination information is generated and sent to the mail server 8. Further, if the output method of FTP is chosen, the data communication control element 116 is enabled to send the data 113B according to the FTP to the URL specified in the destination information. After that, the CPU 111 disconnects the call that was established in step S22 (step S33) and the process ends.

As described in the above, the MFP 1 of the present embodiment is operable in a manner that when the call from the telephone 3 is established and the speech is received, the MFP 1 verifies the voiceprint of the received speech and, when the voiceprint verification succeeds, recognizes the received speech and outputs text data. After extracting the file name and the destination name from the text data, the MFP 1 outputs the data 113B labeled with the file name to the destination designated in the destination information by the output method associated with the designated destination. In this way, a remote user of the MFP 1 may originate a call to the MFP 1 at the telephone 3 and read out the file name and the destination name, in order to output the data 113B with that file name from the MFP 1. This facilitates data output by remote control, while ensuring security of the output data.

The MFP 1 also verifies the voiceprint of the speech received via the microphone 25A and, when the voiceprint verification succeeds, recognizes the speech and outputs text data. After extracting the file name from the text data, the MFP 1 adds the file name to the image data that is output from the image reader element 22 by scanning the document, and stores the image data. This also facilitates storage of the data, while ensuring security.

It is noted that although the present embodiment set forth above has been described with respect to the MFP 1, it will be apparent to those skilled in the art that the present invention may be implemented as a speech command executing program or method to execute the process shown in FIGS. 6 and 7.

It is also noted that the information processing apparatus is not limited to the MFP 1 and the PC may used instead. The information that designates the destination is not limited to the device name and the user name. Other information for designating the location where the destined device resides, such as the name of the company or facilities, or residential addresses may be used. The output data provided upon speech recognition of the speech of the user is not limited to the text data and the binary data may be used instead. For example, the information for designating the destination and the file name are previously registered and, when the speech data that is supplied upon speech recognition of the speech of the user matches the stored speech data, the data output procedure may be executed.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An information processing apparatus, comprising:
a voiceprint data storage element configured to previously store voiceprint data including voiceprint for authenticating a user with the voiceprint;
a speech receiving element configured to receive speech;
a voiceprint verifying element configured to verify the received speech with the voiceprint data;
a speech recognizing element configured to recognize the received speech and to output data corresponding to the received speech, when the voiceprint verification succeeds in the voiceprint verifying element; and
an operation processing element configured to execute an operation in accordance with the data corresponding to the received speech.

2. An information processing apparatus according to claim 1, wherein the speech receiving element includes a communication element connected to a telephone line.

3. An information processing apparatus according to claim 1, further comprising a data storage element configured to store data, wherein
the operation processing element includes
an extracting element configured to extract data identification information for identifying data to be processed and destination designation information for designating a destination of the data from the data corresponding to the received speech, and
a data output element configured to read the data identified by the data identification information from the data storage element, and to output the data in accordance with the destination designation information, when the data identification information and the destination designation information are extracted by the extracting element.

4. An information processing apparatus according to claim 3, wherein
the voiceprint data storage element stores the voiceprint of the user associated with user identification information for identifying the user,
the data storage element includes a user data storage element configured to store user data which associates the user identification information with the data identification information, and
the data output element outputs the data identified by the data identification information extracted, provided that the user data storage element stores the user data that associates the user identification information of the user authenticated by the voiceprint verifying element with the data identification information extracted by the extracting element.

5. An information processing apparatus according to claim 3, further comprising a destination data storage element configured to store destination data which associates the destination designation information with an output method and destination information, wherein
the data output element includes a destination data extracting element configured to extract the destination data including the destination designation information.

6. An information processing apparatus according to claim 3, further comprising a microphone provided separately from the speech receiving element to receive speech, and a data acquiring element configured to acquire data, wherein
the voiceprint verifying element verifies the speech received via the microphone with the voiceprint data,
the speech recognizing element recognizes the speech received via the microphone and outputs data corresponding to the received speech, when the voiceprint verification of the received speech succeeds in the voiceprint verifying element, and
the operation processing element includes
an input data extracting element configured to extract the data identification information from the output data corresponding to the speech received via the microphone, and
a writing element configured to add the extracted data identification information to the data output from the data acquiring element and to write the data and the data identification information into the data storage element, when the data identification information is extracted by the input data extracting element.

7. An information processing apparatus according to claim 1, further comprising
a data acquiring element configured to acquire data, and
a data storage element configured to store data, wherein
the operation processing element includes
an extracting element configured to extract data identification information from the data corresponding to the received speech, and
a writing element configured to add the extracted data identification information to the data output from the data acquiring element and to write the data and the data identification information into the data storage element, when the data identification information is extracted by the extracting element.

8. An information processing apparatus according to claim 7, wherein the speech receiving element includes a microphone.

9. An information processing apparatus according to claim 7, wherein
the voiceprint data storage element stores the voiceprint of the user associated with user identification information for identifying the user,
the data storage element includes a user data storage element configured to store user data which associates the user identification information with the data identification information, and
the writing element includes a user data writing element configured to write into the user data storage element the user data that associates the user identification information of the user who is authenticated by the voiceprint verifying element with the data identification information extracted by the extracting element.

10. An information processing apparatus according to claim 1, wherein the data corresponding to the received speech is text data.

11. A speech command executing program product stored on a computer-readable medium and executed in an information processing apparatus having a voiceprint data storage element which previously stores voiceprint data including a voiceprint to authenticate a user with the voiceprint, the program causing the information processing apparatus to execute the steps of:
receiving speech;
verifying the received speech with the voiceprint data;
recognizing the received speech and outputting data corresponding to the received speech, when the voiceprint verification succeeds in the voiceprint verifying step; and
executing an operation in accordance with the data corresponding to the received speech.

12. A speech command executing method executed in an information processing apparatus having a voiceprint data storage element which previously stores voiceprint data including a voiceprint to authenticate a user with the voiceprint, the method comprising the steps of
receiving speech;
verifying the received speech with the voiceprint data;
recognizing the received speech and outputting data corresponding to the received speech, when the voiceprint verification succeeds in the voiceprint verifying step; and
executing an operation in accordance with the data corresponding to the received speech.

13. A speech command executing method according to claim 12, wherein the speech receiving step includes receiving the speech via a telephone line.

14. A speech command executing method according to claim 12, wherein
the information processing apparatus further includes a data storage element configured to store data,
the step of executing an operation includes
extracting data identification information for identifying data to be processed and destination designation information for designating a destination of the data from the data corresponding to the received speech, and
reading the data identified by the data identification information from the data storage element, and outputting the data in accordance with the destination designation information, when the data identification information and the destination designation information are extracted in the extracting step.

15. A speech command executing method according to claim 14, wherein
the voiceprint data storage element stores the voiceprint of the user associated with the user identification information for identifying the user,
the data storage element includes a user data storage element configured to store user data which associates the user identification information with the data identification information, and
the step of outputting data includes further outputting the data identified by the extracted data identification information, provided that the user data storage element stores the user data that associates the user identification information of the user who is authenticated in the voiceprint verifying step with the data identification information extracted in the extracting step.

16. A speech command executing method according to claim 14, wherein
the information processing apparatus further includes a destination data storage element configured to store destination data which associates the destination designation information with an output method and destination information, and
the data outputting step includes extracting the destination data including the destination designation information.

17. A speech command executing method according to claim 14, wherein the information processing apparatus further includes a microphone for receiving speech,
the method further includes the step of acquiring data, wherein
the voiceprint verifying step verifies the speech received via the microphone with the voiceprint data, and
the speech recognizing step recognizes the speech received via the microphone and outputs the data corresponding to the received speech, when the voiceprint verification of the received speech succeeds in the voiceprint verifying step, and
the operation executing step includes
extracting the data identification information from the output data corresponding to the speech received via the microphone, and
adding the data identification information extracted to the data acquired in the data acquiring step and writing the data and the data identification information into the data storage element, when the data identification information is extracted in the step of extracting the data identification information.

18. A speech command executing method according to claim 12, wherein
the information processing apparatus further includes a data storage element configured to store data, and
the method further includes acquiring data, wherein
the operation executing step includes the steps of
extracting data identification information from the data corresponding to the received speech, and
adding the data identification information extracted to the data acquired in the data acquiring step and writing the data and the data identification information into the data storage element, when the data identification information is extracted in the extracting step.

19. A speech command executing method according to claim 18, wherein
the speech receiving step receives speech entered into the microphone.

20. A speech command executing method according to claim 18, wherein
the voiceprint data storage element stores the voiceprint of the user associated with user identification information for identifying the user,
the data storage element includes a user data storage element configured to store user data which associates the user identification information with the data identification information, and
the writing step includes writing in the user data storage element the user data that associates the user identification information of the user who is authenticated in the voiceprint verifying step with the data identification information extracted in the extracting step.

21. A speech command executing method according to claim 12, wherein the data corresponding to the received speech is text data.
